(19) United States
(12) Patent Application Publication
(10) Pub. No.: US 2026/0011495 A1
(43) Pub. Date: Jan. 8, 2026

(54) LAMINATED CERAMIC CAPACITOR

(71) Applicant: TAIYO YUDEN CO., LTD., Tokyo (JP)

(72) Inventor: Shohei KITAMURA, Tokyo (JP)

(21) Appl. No.: 19/329,318

(22) Filed: Sep. 15, 2025

Related U.S. Application Data
(63) Continuation of application No. PCT/JP2024/003779, filed on Feb. 5, 2024.

(30) Foreign Application Priority Data
Mar. 16, 2023 (JP) 2023-042427

(51) Int. Cl. H01G 4/008; H01G 2/06; H01G 4/12; H01G 4/232; H01G 4/248; H01G 4/30

(52) U.S. Cl. CPC H01G 4/008; H01G 4/12; H01G 4/232; H01G 4/248; H01G 4/30; H01G 2/06

(57) ABSTRACT

Provided is a laminated ceramic capacitor that can combine excellent capacitance and high insulation reliability. An aspect of the present disclosure includes a laminated ceramic capacitor including a body, a first external electrode, and a second external electrode. The body has a first internal electrode layer containing Ni, Fe and Al, a second internal electrode layer, a dielectric layer and a first intermediate layer. The dielectric layer is disposed between the first internal electrode layer and the second internal electrode layer. The first intermediate layer is disposed between the first internal electrode layer and the dielectric layer, and contains Fe and Al. An Al content ratio representing a ratio of a concentration of Al to a concentration of Fe in the first internal electrode layer is from 0.75 to 3.0.

### CROSS-REFERENCE TO RELATED APPLICATIONS

This is a continuation application of a PCT application No. PCT/JP2024/3779 filed on Feb. 5, 2024, which is based on and claims the benefit of priority from Japanese patent Application serial No. 2023-042427 (filed on Mar. 16, 2023). The contents of the PCT and Japanese applications are hereby incorporated by reference in their entirety.

### TECHNICAL FIELD

The disclosure herein relates mainly to a laminated ceramic capacitor and a method of manufacturing the laminated ceramic capacitor. The disclosure herein also relates to a circuit module with the laminated ceramic capacitor and an electronic device with the circuit module.

### BACKGROUND

The miniaturization of electronic devices has created a demand for increased capacitance in laminated ceramic capacitors, which are mounted in electronic devices, without an increase in the size of the capacitors. By reducing the thicknesses of the dielectric and internal electrode layers provided in the laminated ceramic capacitors, their capacitance can be increased without increasing the size of the capacitors.

However, thinner dielectric layers may lead to degraded insulation reliability of the capacitors. To address this issue, it has been proposed to improve the insulation reliability of the capacitors by providing intermediate layers containing trace amounts of metallic elements between the dielectric layers and the internal electrode layers, so that the intermediate layers can increase the Schottky barrier between the dielectric layers and the internal electrode layers. For example, Japanese Patent Application Publication No. 2003-7562 (“the '562 Publication”) discloses a capacitor in which intermediate layers containing a metallic element such as Au are provided between dielectric layers and internal electrode layers. Japanese Patent Application Publication No. 2017-5021 (“the '021 Publication”) discloses that a metallic element is added to an internal electrode layer and that the added metallic element is present at a higher ratio at the interface between the internal electrode layer and a dielectric layer than in a middle region in the thickness direction of the internal electrode layer. The '021 Publication states that the local concentration of the added metallic element at the interface between the internal electrode layer and the dielectric layer causes alloying between Ni, which is the main component of the internal electrode layer, and the added metallic element at the interface. As a result, the capacitor can exhibit improved insulation reliability.

As the metallic elements that can be added to increase the Schottky barrier between the dielectric layers and the internal electrode layers, the '562 Publication discloses Au, Pt, Pd, Ag, and Cu, and the '021 Publication lists Fe, V, Y, and Cu.

The inventor of the present application has placed a focus on Fe, which is inexpensive and easily available, as the metallic element that can be added to increase the Schottky barrier between the dielectric layers and the internal electrode layers.

If intermediate layers containing Fe are formed between the dielectric layers and the internal electrode layers, Fe is likely to diffuse into the dielectric layers. Such incorporation of Fe into the dielectric layers may disadvantageously lead to a decrease in capacitance of the capacitor.

The amount of Fe added to the raw material may be reduced. This is expected to result in a reduced proportion of Fe in the dielectric layers, thereby preventing the decrease in capacitance. If the amount of Fe added to the raw material is reduced, however, sufficient intermediate layers are not formed between the dielectric layers and the internal electrode layers. As a result, the Schottky barrier formed between the dielectric layers and the internal electrode layers may not become high enough to contribute to a significant improvement in the insulation reliability. If sufficient intermediate layers are not formed between the dielectric layers and the internal electrode layers, the capacitor suffers from degraded insulation reliability.

### SUMMARY

It is an object of the present disclosure to solve or alleviate at least part of the drawback mentioned above. Particularly, it is an object of the present disclosure to prevent a decrease in capacitance of a capacitor including an Fe-containing intermediate layer. One of the more particular objects of the disclosure is to provide a laminated ceramic capacitor that can combine excellent capacitance and high insulation reliability. The various inventions disclosed herein may be collectively referred to as “the invention”.

Other objects of the disclosure will be made apparent through the entire description in the specification. The invention disclosed herein may also address drawbacks other than that grasped from the above description. When an advantageous effect of an embodiment is described herein, the advantageous effect suggests an object of the invention corresponding to the embodiment.

An aspect of the present disclosure includes a laminated ceramic capacitor including a body, a first external electrode, and a second external electrode. The body has a first internal electrode layer containing Ni, Fe and Al, a second internal electrode layer, a dielectric layer and a first intermediate layer. The dielectric layer is disposed between the first internal electrode layer and the second internal electrode layer. The first intermediate layer is disposed between the first internal electrode layer and the dielectric layer, and contains Fe and Al. An Al content ratio representing a ratio of a concentration of Al to a concentration of Fe in the first internal electrode layer is from 0.75 to 3.0.

### Advantageous Effects

According to one embodiment of the disclosure, a laminated ceramic capacitor can combine excellent capacitance and high insulation reliability.

### BRIEF DESCRIPTION OF THE DRAWINGS

FIG. 1 is a perspective view schematically showing a laminated ceramic capacitor according to one embodiment of the disclosure.

FIG. 2 is a sectional view schematically showing a section of the capacitor of FIG. 1 along the line I-I.

FIG. 3 is an enlarged sectional view showing, on an enlarged scale, a part (region A) of the section shown in FIG. 2.

FIG. 4 shows an example of line profiles along a scanning line SL1 in FIG. 3.

FIG. 5 shows an example of line profiles along a scanning line SL2 in FIG. 3.

FIG. 6 is an enlarged sectional view showing, on an enlarged scale, a part (region B) of the section shown in FIG. 2.

FIG. 7 is an enlarged sectional view showing, on an enlarged scale, a part (region C) of the section shown in FIG. 2.

FIG. 8 shows an example of a line profile obtained by EDS mapping.

FIG. 9 is a flowchart showing a flow of a manufacturing method of a laminated ceramic capacitor according to one embodiment of the disclosure.

FIG. 10 shows a graph to explain the relationship between an Al content ratio in an internal electrode layer and capacitance.

### DESCRIPTION OF THE PREFERRED EMBODIMENTS

Various embodiments of the disclosure will be described hereinafter with reference to the appended drawings. Throughout the drawings, the same components are denoted by the same or like reference numerals. For convenience of explanation, the drawings are not necessarily drawn to scale. The following embodiments of the disclosure do not limit the scope of the claims. The elements included in the following embodiments are not necessarily essential to solve the problem addressed by the invention.

For convenience of explanation, each of the drawings may show the L axis, the W axis, and the T axis orthogonal to one another. In this specification, the dimensions, arrangement, shape, and other features of each component of a laminated ceramic capacitor 1 may be described with reference to the L, W, and T axes.

### (1) Laminated Ceramic Capacitor 1

### (1-1) Basic Structure of Laminated Ceramic Capacitor 1

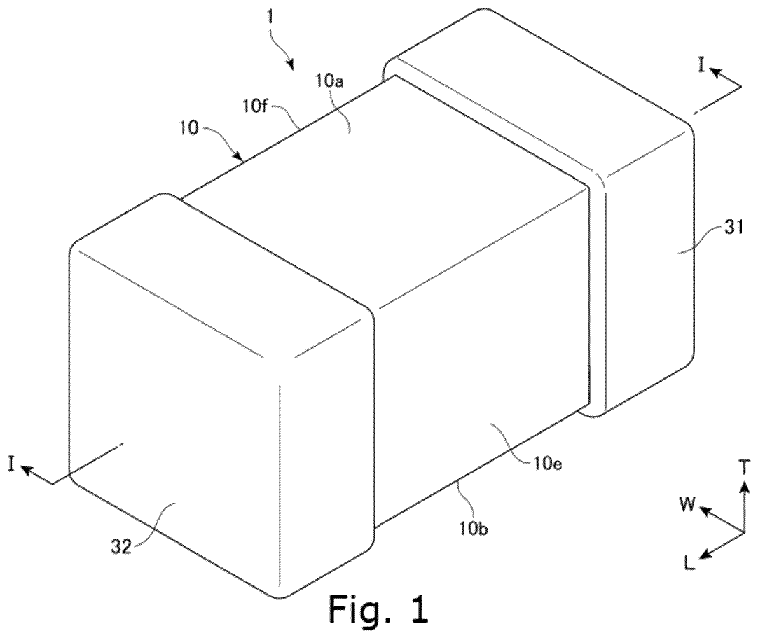

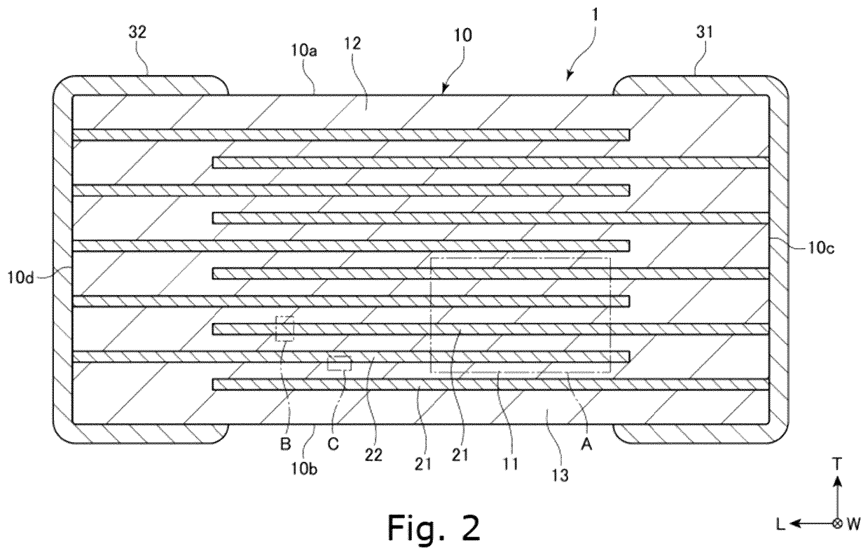

Referring to FIGS. 1 and 2, a description will now be given of the basic structure of a laminated ceramic capacitor 1 according to a first embodiment. FIG. 1 is a perspective view showing the laminated ceramic capacitor 1 according to the first embodiment. FIG. 2 is a sectional view schematically showing a section of the laminated ceramic capacitor 1 along the line I-I.

The laminated ceramic capacitor 1 has a body 10, and a first external electrode 31 and a second external electrode 32 provided on the body 10. The first external electrode 31 is spaced apart from the second external electrode 32. In the example shown in FIG. 2, the first external electrode 31 is spaced apart from the second external electrode 32 in the L-axis direction.

The body 10 has a top surface 10a, a bottom surface 10b, a first end surface 10c, a second end surface 10d, a first side surface 10e, and a second side surface 10f. The outer surface of the body 10 is defined by the top surface 10a, the bottom surface 10b, the first end surface 10c, the second end surface 10d, the first side surface 10e, and the second side surface 10f.

The top surface 10a and the bottom surface 10b form the opposite ends of the body 10 in the height direction (T-axis direction). In other words, the top surface 10a and the bottom surface 10b are opposed to each other in the T-axis direction. The first end surface 10c and the second end surface 10d form the opposite ends of the body 10 in the length direction (L-axis direction). In other words, the first end surface 10c and the second end surface 10d are opposed to each other in the L-axis direction. The first side surface 10e and the second side surface 10f form the opposite ends of the body 10 in the width direction (W-axis direction). In other words, the first side surface 10e and the second side surface 10f are opposed to each other in the W-axis direction. The top surface 10a and the bottom surface 10b are separated from each other by a distance equal to the height of the body 10, the first end surface 10c and the second end surface 10d are separated from each other by a distance equal to the length of the body 10, and the first side surface 10e and the second side surface 10f are separated from each other by a distance equal to the width of the body 10.

The body 10 includes a plurality of dielectric layers 11, a plurality of first internal electrode layers 21, and a plurality of second internal electrode layers 22. A dielectric layer 11 is present between a first internal electrode layer 21 and a second internal electrode layer 22 adjacent to the first internal electrode layer 21. The body 10 is composed of the dielectric layers 11, the first internal electrode layers 21, and the second internal electrode layers 22 stacked together along the lamination direction. In the illustrated embodiment, the dielectric layers 11, the first internal electrode layers 21, and the second internal electrode layers 22 are stacked together along the T-axis direction. The lamination direction may be along the T axis, as shown in the drawings, or may be along the L or W axis. In this specification, the first internal electrode layers 21 and the second internal electrode layers 22 may be referred to collectively as “the internal electrode layers” when it is not necessary to distinguish the first internal electrode layers 21 and the second internal electrode layers 22 from each other.

In the illustrated embodiment, the body 10 is constituted by the dielectric layers 11, the first internal electrode layers 21, and the second internal electrode layers 22 stacked together along the T-axis direction. Therefore, the T-axis direction may be referred to as the lamination direction. An upper cover layer 12 may be provided on the top surface of the laminate. A lower cover layer 13 may be provided on the bottom surface of the laminate. The upper cover layer 12 and the lower cover layer 13 may be formed of the same material as the dielectric layers 11. The upper cover layer 12 and the lower cover layer 13 may be a part of the body 10.

Each of the first internal electrode layers 21 has one end led toward the outside of the body 10. The first internal electrode layer 21 is connected to the first external electrode 31 provided on the surface of the body 10. Each of the second internal electrode layers 22 has one end led toward the outside of the body 10. The second internal electrode layer 22 is connected to the second external electrode 32 provided on the surface of the body 10. In the illustrated embodiment, the first internal electrode layer 21 is led from one end in the L-axis direction toward the outside of the body 10. The first internal electrode layer 21 is connected to the first external electrode 31 at one end of the body 10 in the L-axis direction. The second internal electrode layer 22 is led from the other end in the L-axis direction toward the outside of the body 10. The second internal electrode layer 22 is connected to the second external electrode 32 at the other end of the body 10 in the L-axis direction. In the example shown in FIG. 2, the first and second internal electrode layers 21 and 22 are respectively led out to the first and second end surfaces 10c and 10d, which are opposed to each other, but the first and second internal electrode layers 21 and 22 can be led out through various surfaces of the body 10 in accordance with the locations and the shapes of the first and second external electrodes 31 and 32. For example, if both the first and second external electrodes 31 and 32 are located on the bottom surface 10b, both the first and second internal electrode layers 21 and 22 are led out through the bottom surface. The first and second external electrodes 31 and 32 may be located on any of the surfaces of the body 10 as long as they are separated from each other.

When voltage is applied between the first and second external electrodes 31 and 32, capacitance is generated between the first and second internal electrode layers 21 and 22.

As will be described below, first intermediate layers 41 are provided between the dielectric layers 11 and the first internal electrode layers 21, and second intermediate layers 42 are provided between the dielectric layers 11 and the second internal electrode layers 22. FIGS. 1 and 2, however, do not show the first and second intermediate layers 41 and 42. In this specification, the first intermediate layers 41 and the second intermediate layers 42 may be referred to collectively as “the intermediate layers” when it is not necessary to distinguish the first intermediate layers 41 and the second intermediate layers 42 from each other.

FIG. 2 shows five each of the first and second internal electrode layers 21 and 22 for simplicity of illustration, but the laminated ceramic capacitor 1 may include any number of layers stacked together. The laminated ceramic capacitor 1 may include, for example, 300 to 1000 layers formed of the first and second internal electrode layers 21 and 22. In other words, the number of stacked layers in the laminated ceramic capacitor 1 may be 300 to 1000.

The laminated ceramic capacitor 1 may be mounted on an electronic circuit board. The electronic circuit board having the laminated ceramic capacitor 1 mounted thereon may be referred to as a circuit module. Various electronic components other than the laminated ceramic capacitor 1 may also be mounted on the circuit module. The circuit module may be installed in various electronic devices. The electronic devices in which the circuit module can be installed include smartphones, tablets, game consoles, electrical components of automobiles, servers, and various other electronic devices.

In one aspect, the body 10 may be configured to have a rectangular parallelepiped shape. The term “rectangular parallelepiped” or “rectangular parallelepiped shape” used herein is not intended to mean solely “rectangular parallelepiped” in a mathematically strict sense. As described below, the corners and/or edges of the body 10 may be rounded. The dimensions and the shape of the body 10 are not limited to those specified herein.

In one aspect, the laminated ceramic capacitor 1 has a dimension in the L-axis direction (length) of 0.2 mm to 2.5 mm, a dimension in the W-axis direction (width) of 0.1 mm to 3.5 mm, and a dimension in the T-axis direction (height) of 0.1 mm to 3.0 mm. In one aspect, the length of the laminated ceramic capacitor 1 may be larger than the width thereof. In one aspect, the height of the laminated ceramic capacitor 1 may be larger than the width thereof. In one aspect, the width of the capacitor 1 may be larger than the length thereof.

### (1-2) Dielectric Layer 11

The dielectric layers 11 contain as their main component an oxide represented by a chemical formula ABO₃. The oxide may have a perovskite structure. A component that is at least 50 wt % of the dielectric layers 11 with reference to the total mass of the dielectric layers 11 can be regarded as the main component of the dielectric layers 11. When the dielectric layers 11 contain 50 wt % or more of the oxide represented by the chemical formula ABO₃, the dielectric layers 11 can be considered to contain the oxide represented by the chemical formula ABO₃ as their main component. The dielectric layers 11 preferably contain at least 60 wt %, 70 wt %, 80 wt %, or 90 wt % of the oxide represented by the chemical formula ABO₃.

In the chemical formula ABO₃, “A” is at least one element selected from the group consisting of Ba (barium), Sr (strontium), Ca (calcium), and Mg (magnesium). In the chemical formula ABO₃, “B” is at least one element selected from the group consisting of Ti (titanium), Zr (zirconium), and Hf (hafnium). When the oxide represented by the chemical formula ABO₃ has a perovskite structure, the elements “A” and “B” are located at the A site and the B site of the perovskite structure, respectively. Examples of the oxides contained in the dielectric layers 11 as their main component include BaTiO₃ (barium titanate), CaZrO₃ (calcium zirconate), CaTiO₃ (calcium titanate), SrTiO₃ (strontium titanate), and MgTiO₃ (magnesium titanate).

The oxide contained in the dielectric layers 11 as the main component may be an oxide represented by the chemical formula Ba_{1-x-y}CaₓSr_{y}Ti_{1-z}Zr_{z}O₃ (0≤x≤≤1, 0≤y≤1, 0≤z≤1). Examples of this type of oxide include strontium barium titanate, calcium barium titanate, barium zirconate, barium zirconate titanate, calcium zirconate titanate, and calcium barium zirconate titanate.

The dielectric layers 11 may contain one or more additive elements in addition to the main component oxide. In one aspect, the one or more additive elements contained in the dielectric layers 11 are selected from the group consisting of Fe (iron), Ni (nickel), Mo (molybdenum), Nb (niobium), Ta (tantalum), W (tungsten), Mg (magnesium), Mn (manganese), V (vanadium), and Cr (chromium). The dielectric layers 11 may contain two or more of the above additive elements.

The dielectric layers 11 may contain oxides of rare earth elements in addition to the main component oxide. The oxides of rare earth elements contained in the dielectric layers 11 may be oxides of at least one rare earth element selected from the group consisting of Y (yttrium), Sm (samarium), Eu (europium), Gd (gadolinium), Tb (terbium), Dy (dysprosium), Ho (holmium), Er (erbium), Tm (thulium), and Yb (ytterbium). The dielectric layers 11 may contain oxides of two or more rare earth elements.

The dielectric layers 11 may contain yet another type of oxide. The dielectric layers 11 may contain oxides of at least one element selected from the group consisting of, for example, Co (cobalt), Ni (nickel), Li (lithium), B (boron), Na (sodium), K (potassium), and Si (silicon). The dielectric layers 11 may contain oxides of two or more of these elements.

The dielectric layers 11 may contain glass containing at least one element selected from the group consisting of Co, Ni, Li, B, Na, K, and Si.

In one aspect, the thickness (the dimension in the T-axis direction) of each dielectric layer 11 is 0.2 to 10 μm.

(1-3) First Internal Electrode Layers 21 and Second Internal Electrode Layers 22

In one aspect, the first internal electrode layers 21 contain Ni as the main component thereof. A component that is at least 50 wt % of the first internal electrode layers 21 with reference to the total mass of the first internal electrode layers 21 can be regarded as the main component of the first internal electrode layers 21. The first internal electrode layers 21 preferably contain 60 wt % or more, 70 wt % or more, 80 wt % or more, or 90 wt % or more of Ni as the main component thereof.

In one aspect, the first internal electrode layers 21 contain Fe and Al in addition to Ni. In one aspect, the concentration of Fe in the first internal electrode layers 21 is from 0.01 at % to 5 at %.

In one aspect, the ratio of the concentration of Al to that of Fe in the first internal electrode layers 21 (hereinafter referred to as “the Al content ratio”) is from 0.75 to 3.0. The Al content ratio is preferably from 0.75 to 2.5. The Al content ratio is more preferably from 0.75 to 1.5. The Al content ratio is further preferably from 1.0 to 1.5. The Al content ratio is yet further preferably from 1.0 to 1.25. As used herein, the concentration of Fe in the first internal electrode layers 21 means the atomic ratio (atomic percentage) (at %) of Fe relative to 100 at % of Ni contained in the first internal electrode layers 21, and the concentration of Al in the first internal electrode layers 21 means the atomic ratio (at %) of Al relative to 100 at % of Ni in the first internal electrode layers 21.

The first internal electrode layers 21 may contain at least one noble metal element selected from the group consisting of Au (gold), Pt (platinum), and Ag (silver), in addition to Ni, Fe and Al. In one aspect, the concentration of the above-mentioned noble metal elements in the first internal electrode layers 21 is from 0.01 at % to 5 at %. If the first internal electrode layers 21 contain two or more of the noble metal elements, the total concentration of these two or more noble metal elements is from 0.01 at % to 5 at %. With the noble metal elements contained in the first internal electrode layers 21, the laminated ceramic capacitor 1 can achieve improved capacitance and insulation reliability.

In one embodiment, the first internal electrode layers 21 can contain secondary elements in addition to or in place of the above-mentioned noble metal elements. The secondary elements that can be contained in the first internal electrode layers 21 are one or more elements selected from the group consisting of, for example, As (arsenic), Co, Cr, Cu, Fe, In (indium), Ir (iridium), Mg, Os (osmium), Pd (palladium), Re (rhenium), Rh (rhodium), Ru (ruthenium), Se (selenium), Sn, Ge (germanium), Te (tellurium), W, Y (yttrium), Zn (zinc), and Mo.

The above description of the components of the first internal electrode layers 21 and the concentrations of the respective components also applies to the components of the second internal electrode layers 22. Specifically, the second internal electrode layers 22 contain Ni as the main component and additionally contains Fe and Al in addition to Ni. The description of the concentrations of Fe and Al contained in the first internal electrode layers 21 also applies to the concentrations of Fe and Al contained in the second internal electrode layers 22. For example, the Al content ratio in the second internal electrode layers 22, which represents the ratio of the concentration of Al to that of Fe in the second internal electrode layers 22, is from 0.75 to 3.0. The Al content ratio in the second internal electrode layers 22 is preferably from 0.75 to 2.5. The Al content ratio in the second internal electrode layers 22 is more preferably from 0.75 to 1.5. The Al content ratio in the second internal electrode layers 22 is further preferably from 1.0 to 1.5. The Al content ratio in the second internal electrode layers 22 is yet further preferably from 1.0 to 1.25. As used herein, the concentration of Fe in the second internal electrode layers 22 means the atomic ratio (at %) of Fe relative to 100 at % of Ni contained in the second internal electrode layers 22, and the concentration of Al in the second internal electrode layers 22 means the atomic ratio (at %) of Al relative to 100 at % of Ni in the second internal electrode layers 22.

In one aspect, the thickness (the dimension in the T-axis direction) of each first internal electrode layer 21 is from 0.2 μm to 3 μm. In one aspect, the thickness of the first internal electrode layer 21 is preferably 0.4 μm or less. The description of the thickness of each first internal electrode layer 21 also applies to the thickness of each second internal electrode layer 22.

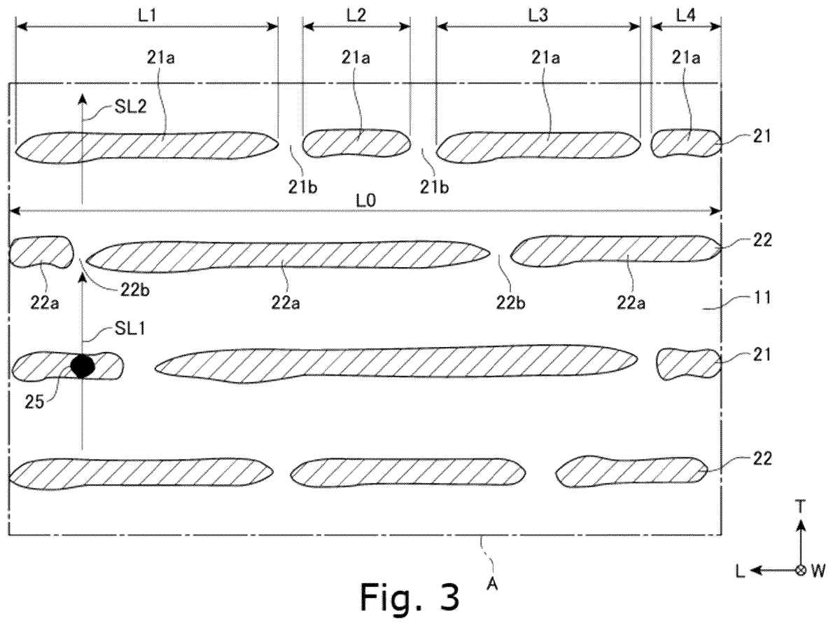

In one aspect, the continuity of the internal electrode layers in the laminated ceramic capacitor 1 is preferably 75% or higher. The continuity of the internal electrode layers will be further described with reference to FIG. 3. FIG. 3 is an enlarged sectional view showing, on an enlarged scale, a region A of the section of the body 10 shown in FIG. 2. The region A has a dimension L0 of about 50 μm in the L-axis direction.

As shown in FIG. 3, each first internal electrode layer 21 includes a plurality of electrode regions 21a containing Fe, and a plurality of non-electrode regions 21b between the electrode regions 21a. The non-electrode regions 21b are more insulating than the electrode regions 21a. The non-electrode regions 21b are occupied by, for example, oxides of the elements contained in the first internal electrode layer 21, a portion of the dielectric layer 11, and/or voids. The non-electrode regions 21b can be caused through vaporization of the binder resin in the precursor of the first internal electrode layer 21 during the degreasing process of the precursor of the first internal electrode layer 21, or through oxidation of the elements in the precursor of the first internal electrode layer 21 during the firing process. If the first internal electrode layer 21 contains Fe and Al in appropriate proportions, a segregated part containing Fe and Al are generated. The segregated part will be described below. If the first internal electrode layer 21 contains an excessive amount of Al relative to that of Fe, Al can be oxidized during the firing process into aluminum oxide, which is electrically insulating. The aluminum oxide thus formed may occupy part of the non-electrode regions 21b.

The continuity of the first internal electrode layers 21 can be calculated as follows. First, the laminated ceramic capacitor 1 is polished so that an LT surface can be exposed as an observation surface. Subsequently, a region A on this observation surface is observed by a scanning electron microscope (SEM), and the distributions of Ni, Fe, Al, and O are examined by EDS mapping. Based on the distributions of Ni, Fe, and Al and the distribution of O, the regions that do not overlap with the 0 distribution are identified as the electrode regions 21a, which are made of metals. The lengths of the electrode regions 21a are measured, and the measured lengths L1, L2, . . . , Ln are totaled. The total length of the electrode regions 21a in the region A is divided by the length L0 of the measured region (i.e., (L1+L2+ . . . . Ln)/L0), and the resulting value can be defined as the continuity of a single first internal electrode layer 21. The body 10 includes a plurality of first internal electrode layers 21, and the continuity can vary among the plurality of first internal electrode layers 21. Thus, ten different first internal electrode layers 21 can be selected, and the average of the continuities calculated for these selected first internal electrode layers 21 can be defined as the continuity of the first internal electrode layers 21 in the laminated ceramic capacitor 1.

Similar to the first internal electrode layers 21, the second internal electrode layers 22 can be each partitioned into electrode regions and non-electrode regions. Specifically, as shown in FIG. 3, each second internal electrode layer 22 includes a plurality of electrode regions 22a containing the main component metal element, and a plurality of non-electrode regions 22b between the electrode regions 22a. The continuity of the second internal electrode layers 22 is defined in the same way as that of the first internal electrode layers 21. Further, the average of the continuity of the first internal electrode layers 21 and the continuity of the second internal electrode layers 22 can be defined as the continuity of the internal electrode layers in the laminated ceramic capacitor 1.

In the laminated ceramic capacitor 1, capacitance is generated in the regions where the electrode regions 21a of the first internal electrode layers 21 face the electrode regions 22a of the second internal electrode layers 22 in the lamination direction. Conversely, the non-electrode regions 21b and 22b do not contribute to the generation of capacitance. Therefore, in order to provide the laminated ceramic capacitor 1 with a high capacitance, the continuity of the internal electrode layers should desirably be high. In one aspect, the continuity of the internal electrode layers is 75% or higher. This provides the laminated ceramic capacitor 1 with a high capacitance.

### (1-4) Segregated Part 25

Each first internal electrode layer 21 may include a segregated part 25 where both Fe and Al are segregated. The segregated part 25 occupies part of the first internal electrode layer 21 and contains Fe and Al at a higher concentration than the other parts of the first internal electrode layer 21. The first internal electrode layer 21 may include more than one segregated part 25. The segregated part 25 may be sized such that its breadth is 1/10 or more of the thickness of the first internal electrode layer 21. For example, when the thickness of the first internal electrode layer 21 is 0.2 μm, the breadth of the segregated part 25 is 20 nm or more. In the segregated part 25, Fe and Al may be alloyed. The presence of the segregated part 25 in the first internal electrode layer 21 can be verified in the following manner.

To begin with, the laminated ceramic capacitor 1 is embedded in resin, and the laminated ceramic capacitor 1 embedded in the resin is polished to near the middle in the W-axis direction, so that an LT surface becomes an observation surface. The section of the laminated ceramic capacitor 1 that is exposed by the polishing is observed using a scanning electron microscope (SEM) equipped with an EDS detector at a magnification of 5000x, to obtain mapping images of the quantitative elements. If the main component of the dielectric layers 11 is barium titanate, the quantitative elements are Ni, Fe, Al, and Ba. For example, the EDS measurements involve measuring the intensities of the Ni Kα, Fe Kα, Al K, and Ba Lα lines to obtain mapping data for the quantitative elements.

Next, a line analysis is performed based on the mapping data obtained. For example, as shown in FIG. 3, scanning lines SL1 and SL2 extend in the T-axis direction and through the first internal electrode layers 21. Along the scanning lines SL1 and SL2, the mapping data of the quantitative elements are reconstructed to create line profiles for the respective quantitative elements. The scanning line SL1 passes through the segregated part 25 in the first internal electrode layer 21, and the scanning line SL2 passes through the part of the first internal electrode layer 21 where the segregated part 25 does not exist. The lengths of the scanning lines SL1 and SL2 are 1 μm to 1.5 μm, for example. The lengths of the scanning lines SL1 and SL2 can be adaptively determined by the thickness of each first internal electrode layer 21.

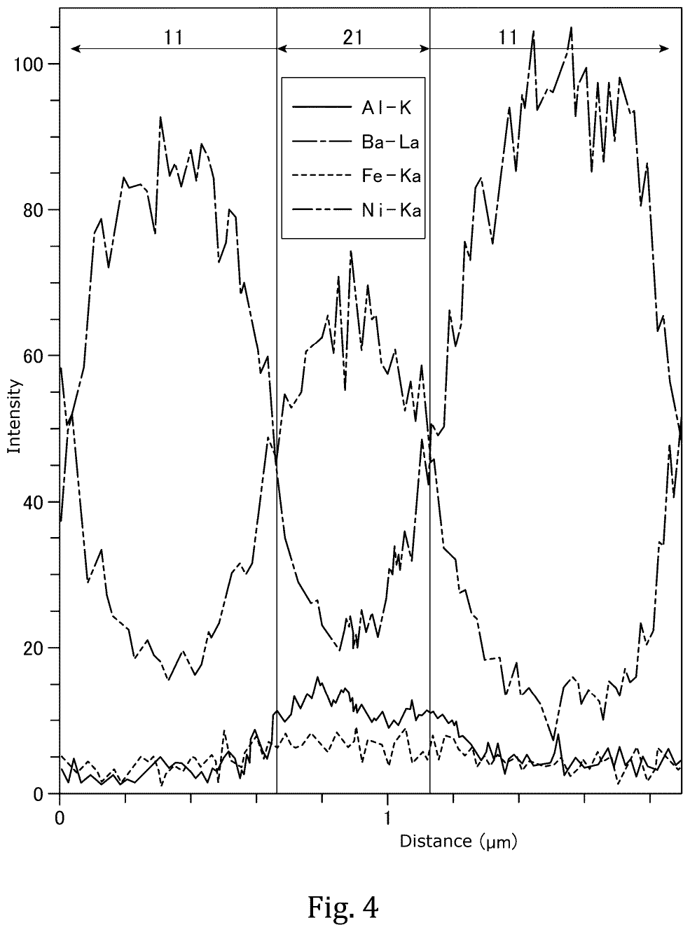

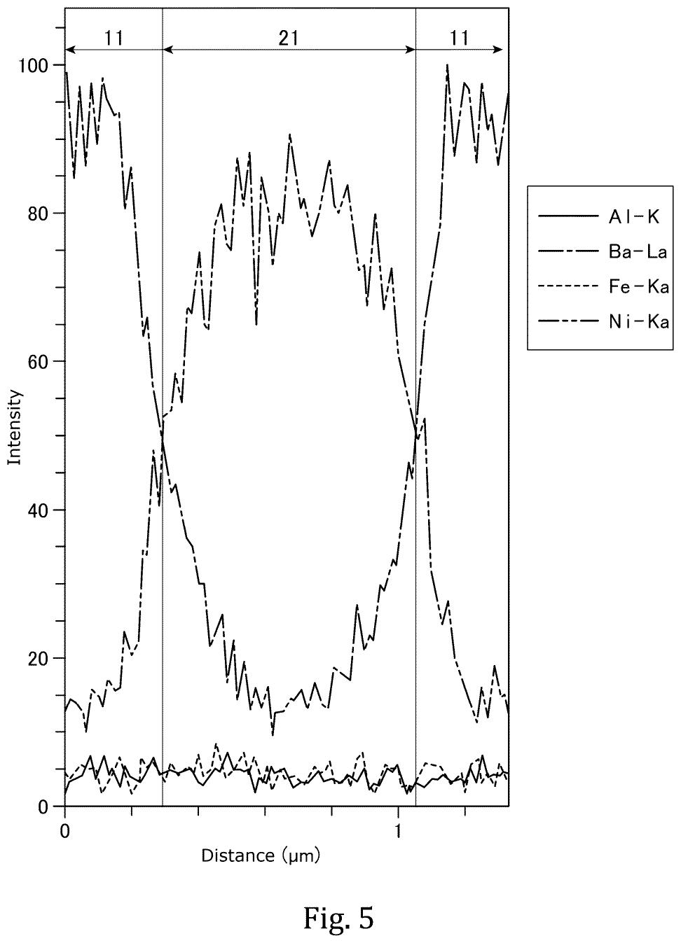

FIG. 4 shows an example of the line profiles obtained by reconstructing the mapping data along the scanning line SL1, and FIG. 5 shows an example of the line profiles obtained by reconstructing the mapping data along the scanning line SL2. In FIGS. 4 and 5, the horizontal axis represents the detection position on the scanning lines SL1 and SL2, and the vertical axis represents the detection intensity calculated based on the counts of Ni, Fe, Al, and Ba at each detection position. FIG. 4 shows that the detection intensity of Ni exceeds that of Ba from the position approximately 0.7 μm away from the scanning start portion to the position approximately 1.1 μm away. Therefore, the part from the about 0.2-μm position to the about 0.7-μm position corresponds to the first internal electrode layer 21. FIG. 5 shows that the detection intensity of Ni exceeds that of Ba from the position approximately 0.3 μm away from the scanning start portion to the position approximately 1.1 μm away. Therefore, the part from the about 0.3-μm position to the about 1.1-μm position corresponds to the first internal electrode layer 21. As shown in FIG. 5, when the scanning line SL2 does not pass through the segregated part 25, the detection intensities of Fe and Al are generally constant even within the first internal electrode layer 21 where the detection intensity of Ni is higher than that of Ba. As shown in FIG. 4, on the other hand, when the scanning line SL1 passes through the segregated part 25, the detection intensities of Fe and Al are both higher within the first internal electrode layer 21 where the detection intensity of Ni is higher than that of Ba. The peak of the detection intensity of Ni within the first internal electrode layer 21 shown in FIG. 4 is lower than the peak of the detection intensity of Ni within the first internal electrode layer 21 shown in FIG. 5. In the line profiles shown in FIG. 4, while the detection intensity of Ni is low within the first internal electrode layer 21, the detection intensities of Fe and Al are high. This can verify that the segregated part 25 is generated in the region the scanning line SL1 passes through. As will be described below, the first intermediate layers 41, which have a high concentration of Fe, are formed between the first internal electrode layers 21 and the dielectric layers 11, but the line profiles shown in FIGS. 4 and 5 show no Fe peak at the boundaries between the first internal electrode layers 21 and the dielectric layers 11 due to resolution limitations. The fact that no Fe peak appears at the boundaries between the first internal electrode layers 21 and the dielectric layers 11 in FIGS. 4 and 5 is attributable to the limitation of the resolution of the EDS mapping, and does not indicate that the first intermediate layers 41 are not present between the first internal electrode layers 21 and the dielectric layers 11.

Since Fe and Al are present in trace amounts in the first internal electrode layer 21 compared to Ni, the line profiles of Fe and Al constructed along the scanning line passing through the segregated part 25 may not show the same distinct peaks as Ni. If the first internal electrode layer 21 includes a region where the detection intensities of Fe and Al are both more than five times the square root of their respective background levels, the region can be identified as the segregated part 25 where both Fe and Al are segregated. In light of this criterion, the line profiles shown in FIG. 4 indicate the presence of the segregated part 25 on the scanning line SL1. Conversely, the line profiles shown in FIG. 5 indicate that the segregated part 25 is not present on the scanning line SL2.

As described above, scanning lines are set that pass through the first internal electrode layers 21, and line profiles are reconstructed along the scanning lines and analyzed. In this way, it becomes possible to determine whether or not the segregated part 25 exists on the scanning lines. Any other analytical methods than that described above can be used to verify the presence of the segregated part 25.

The segregated part 25 is considered to be a metal part containing both Fe and Al, and thus electrically conductive. The presence of the segregated part 25 in the first internal electrode layers 21 can thus lead to improvement in the continuity of the first internal electrode layers 21.

The segregated part 25 may be generated in the second internal electrode layers 22. The segregated part 25 may be present in both of the first and second internal electrode layers 21 and 22. The segregated part 25 may be formed in each of the first internal electrode layers 21, or in only some of the first internal electrode layers 21. The segregated part 25 may be formed in each of the second internal electrode layers 22, or in only some of the second internal electrode layers 22. The segregated part 25 may be present such that it penetrates the first or second internal electrode layer 21 or 22 in the lamination direction. The segregated part 25 may be embedded within the first or second internal electrode layer 21 or 22. The segregated part 25 may be partly exposed from the first or second internal electrode layer 21 or 22.

### (1-5) First External Electrode 31 and Second External Electrode 32

In one aspect, the first and second external electrodes 31 and 32 are formed by applying a conductive paste to the body 10 and heating the conductive paste. The conductive paste can contain at least one substance from the group consisting of Ag, Pd, Au, Pt, Ni, Sn, Cu, W, Ti, and alloys of these.

### (1-6) First Intermediate Layer 41 and Second Intermediate Layer 42

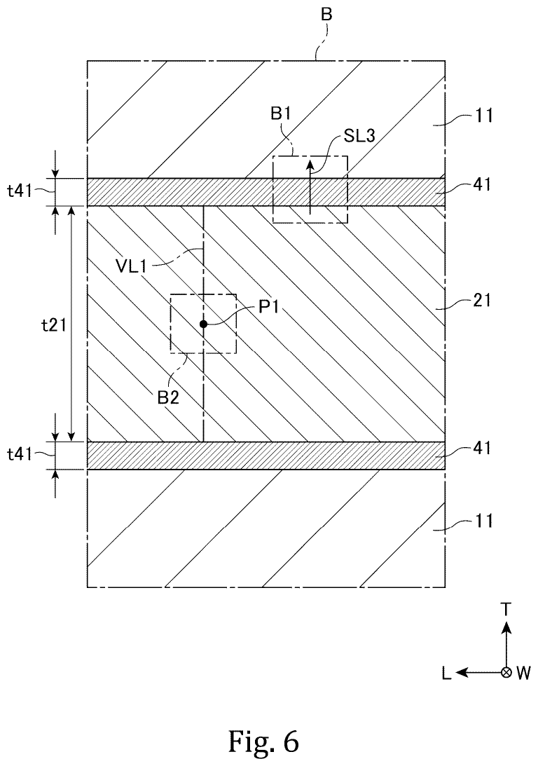

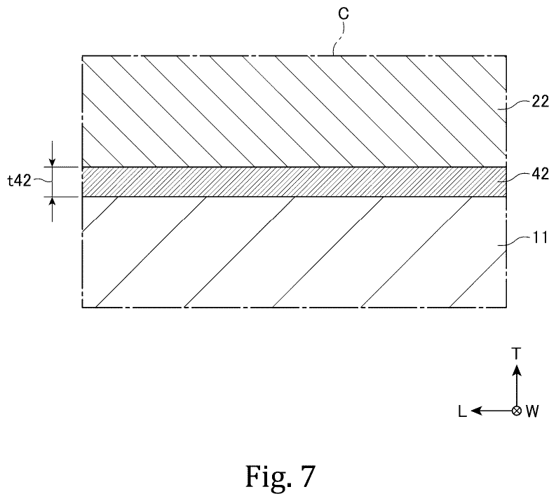

Next, with reference to FIGS. 6 and 7, a description is given of the first and second intermediate layers 41 and 42. The first intermediate layers 41 will now be described with reference to FIG. 6. FIG. 6 is an enlarged sectional view showing, on an enlarged scale, a region B of the section of the body 10 shown in FIG. 2. The region B includes a given one of the first internal electrode layers 21 provided in the body 10 and the dielectric layers 11 above and below the given first internal electrode layer 21. Stated differently, the region B extends from the dielectric layer 11 below the first internal electrode layer 21, over the first internal electrode layer 21, and to the dielectric layer 11 above the first internal electrode layer 21.

As shown in FIG. 6, the first intermediate layers 41 are provided between the dielectric layers 11 and the first internal electrode layers 21 in one embodiment. The first intermediate layers 41 contain Fe. According to one aspect, the concentration of Fe in the first intermediate layers 41 is higher than that in the first internal electrode layers 21. The first intermediate layers 41 may contain Al.

The first intermediate layers 41, which have a higher concentration of Fe than the first internal electrode layers 21, allow for a higher Schottky barrier to be formed between the dielectric layers 11 and the first internal electrode layers 21. The increased height of the Schottky barrier formed between the dielectric layers 11 and the first internal electrode layers 21 can prevent an increase in leakage current, as a result of which the laminated ceramic capacitor 1 can achieve improved insulation reliability. In other words, the service life of the laminated ceramic capacitor 1 can be extended. The first intermediate layers 41 may contain Al. Like Fe, Al can also contribute to an increase in the height of the Schottky barrier formed between the dielectric layers 11 and the first internal electrode layers 21. Due to the presence of Al in the first intermediate layers 41, the laminated ceramic capacitor 1 can achieve further improved insulation reliability.

The second intermediate layers 42 will now be described with reference to FIG. 7. FIG. 7 is an enlarged sectional view showing, on an enlarged scale, a region C of the section of the body 10 shown in FIG. 2. The region C includes a given one of the second internal electrode layers 22 provided in the body 10, and the dielectric layer 11 above or below the given second internal electrode layer 22. As shown in FIG. 7, the second intermediate layers 42 are provided between the dielectric layers 11 and the second internal electrode layers 22. The second intermediate layers 42 contain Fe. According to one aspect, the concentration of Fe in the second intermediate layers 42 is higher than that in the second internal electrode layers 22. The second intermediate layers 42 may contain Al. The second intermediate layers 42 allow for a higher Schottky barrier to be formed between the dielectric layers 11 and the second internal electrode layers 22. The increased height of the Schottky barrier formed between the dielectric layers 11 and the second internal electrode layers 22 can prevent an increase in leakage current, as a result of which the laminated ceramic capacitor 1 can achieve improved insulation reliability. In other words, the service life of the laminated ceramic capacitor 1 can be extended.

The thickness t41 (dimension in the T-axis direction) of each first intermediate layer 41 is, for example, 0.2 nm to 3.0 nm. The lower limit of the thickness t41 of the first intermediate layer 41 may be 0.3 nm, 0.4 nm, or 0.5 nm. The upper limit of the thickness t41 of the first intermediate layer 41 may be 2.0 nm, 1.5 nm, or 1.3 nm. The thickness t42 of each second intermediate layer 42 may be comparable to the thickness t41 of the first intermediate layer 41.

In the illustrated embodiment, the body 10 includes the first intermediate layers 41 and the second intermediate layers 42. This configuration allows the Schottky barrier to be increased in both the regions between the dielectric layers 11 and the first internal electrode layers 21 and the regions between the dielectric layers 11 and the second internal electrode layers 22. In one aspect, it is possible that the body 10 includes the first intermediate layers 41 but does not include the second intermediate layers 42. In this case, the Schottky barrier between the dielectric layers 11 and the first internal electrode layers 21 can be increased. In one aspect, it is possible that the body 10 includes the second intermediate layers 42 but does not include the first intermediate layers 41. In this case, the Schottky barrier between the dielectric layers 11 and the second internal electrode layers 22 can be increased.

Each first intermediate layer 41 may entirely cover a corresponding first internal electrode layers 21. Each first intermediate layer 41 may cover only a portion of the corresponding first internal electrode layer 21. The first intermediate layers 41 preferably cover 80% or more of the entire top and bottom surfaces of the first internal electrode layers 21 to reduce leakage current. Likewise, each second intermediate layer 42 may entirely cover a corresponding second internal electrode layer 22. Each second intermediate layer 42 may cover only a portion of the corresponding second internal electrode layer 22. The second intermediate layers 42 preferably cover 80% or more of the entire top and bottom surfaces of the second internal electrode layers 22 to reduce leakage current.

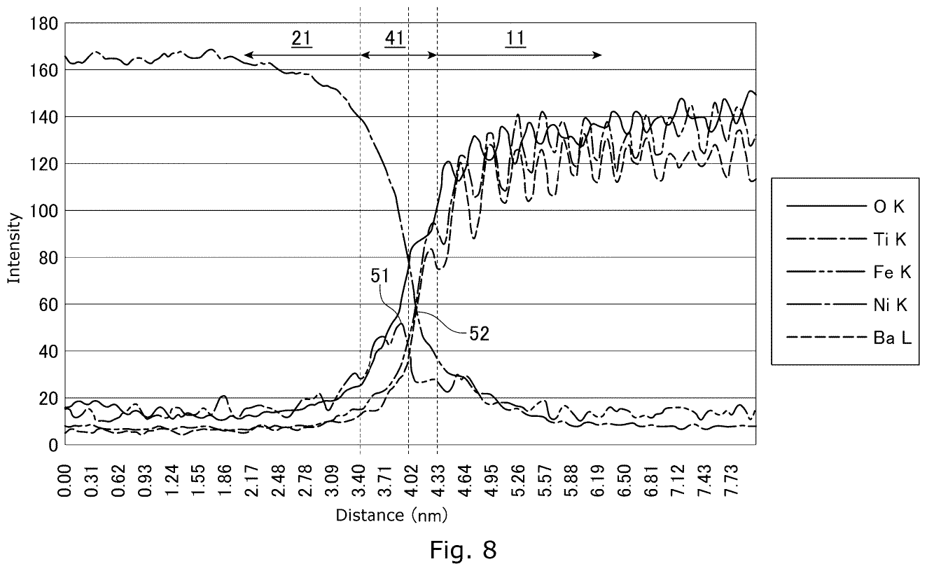

If the first intermediate layers 41 are not visible in electron microscope images, the presence of the first intermediate layers 41 can be confirmed as follows. An observation region extending from a first internal electrode layer 21 to a dielectric layer 11 is set on a section of the body 10 and subjected to TEM-EDS to obtain mapping data of the Fe element. The detection of the first intermediate layers 41 by TEM-EDS analysis can proceed, for example, as follows.
(1) An analysis sample is prepared by thinly slicing the body 10 such that a surface parallel to the plane containing the T-axis (e.g., LT plane) is exposed as an observation surface, and an observation region spanning from a first internal electrode layer 21 to a dielectric layer 11 is set on the observation surface of the thinly sliced analysis sample. Since the LT plane of the body 10 is shown in FIG. 6, the following description assumes that FIG. 6 shows the observation surface of the thinly sliced analysis sample. FIG. 6 shows an observation region B1 as an example of the observation region for TEM-EDS analysis. The observation region B1 undergoes TEM-EDS, to obtain mapping data of the quantitative elements contained in the observation region B1 of the analysis sample. The observation region B1 is, for example, a square region with sides of 15 nm. The quantitative elements include the elements contained in the main component oxide of the dielectric layer 11 (e.g., Ba, Ti, and O when the main component oxide is BaTiO₃), Ni, and Fe. The quantitative elements may include Al.
(2) Next, a line analysis is performed based on the obtained mapping data. Specifically, the mapping data of the quantitative elements are reconstructed along a scanning line SL3 that extends in the observation region B1 from the first internal electrode layer 21 to the dielectric layer 11, thereby creating line profiles for the respective quantitative elements. The length of the scanning line SL3 is 8 nm, for example. The length of the scanning line SL3 for obtaining the line profiles can be changed appropriately. FIG. 8 shows an example of the line profiles reconstructed along the scanning line SL3 from the mapping data obtained by TEM-EDS in the region B1 of the analysis sample. The line profiles in FIG. 8 are an example of the graphs obtained as follows: an analysis sample is prepared from the laminated ceramic capacitor 1 including the dielectric layers 11 that are principally composed of BaTiO₃, and subjected to TEM-EDS to obtain mapping data of the elements including Ba, Ti, O, Ni and Fe, and the mapping data is then reconstructed along a scanning line SL. In FIG. 8, the horizontal axis represents the detection position on the scanning line SL3, and the vertical axis represents the detection intensities calculated based on the counts of Ba, Ti, O, Ni and Fe at the detection positions.
(3) If the peak of the line profile of Fe is located in the vicinity of the intersection where the line profile of the non-oxygen element of the main component oxide of the dielectric layer 11 (e.g., Ba) intersects with the line profile of the main component metal element of the first internal electrode layer 21 (hereinafter referred to as “profile intersection”), it can be determined that a first intermediate layer 41 exists in the laminated ceramic capacitor 1 from which the analysis sample is taken. For example, if the distance between the position of the profile intersection and the position of the peak of the Fe line profile is equal to or less than a predetermined threshold value, the peak of the Fe line profile can be determined to be in the vicinity of the profile intersection. The predetermined threshold value can be, for example, 1 nm, 0.9 nm, 0.8 nm, 0.7 nm, 0.6 nm or 0.5 nm.

In the example shown in FIG. 8, the line profile of Ba in BaTiO₃ contained as the main component in the dielectric layer 11 intersects the line profile of Ni contained as the main component in the first internal electrode layer 21 at about 4.1 nm from the scanning start position. In other words, the profile intersection 52 where the Ba line profile intersects the Ni line profile is about 4.1 nm from the scanning start position. Here, the peak 51 of the Fe line profile is located at about 3.9 nm from the scanning start position. Since the peak 51 of the Fe line profile is located about 0.2 nm away from the profile intersection 52, which is less than the threshold value, it is determined that a first intermediate layer 41 exists in the region including the peak 51.

Note that the line profiles shown in FIG. 8 are significantly different in resolution from the line profiles shown in FIGS. 4 and 5. The line profiles in FIG. 8 are created by reconstructing the concentration map along the 8-nm-long scanning line SL3, whereas the line profiles in FIGS. 4 and 5 are created by reconstructing the concentration map along the scanning lines SL1 and SL2, which are 1 μm or longer. Because of the difference in resolution, the peak of the Fe line profile cannot be clearly seen near the intersection of the Ni line profile and the Ba line profile in FIGS. 4 and 5. In FIGS. 4 and 5, the length of the scanning lines SL1 and SL2 is about 1 μm, and detection is performed at intervals of 10 nm or more on these scanning lines. Therefore, the Fe line profiles shown in FIGS. 4 and 5 do not accurately detect the concentration of Fe present in the first intermediate layer 41, which has a thickness of several nanometers. Therefore, in the Fe line profiles shown in FIGS. 4 and 5, no distinct peak is recognizable in the region where the first intermediate layer 41 exists (near the intersection of the Ni line profile and the Ba line profile). As described above, unlike FIG. 8, FIGS. 4 and 5 do not distinctly show the Fe peak between the dielectric layer 11 and the first internal electrode layer 21 since the procedure for obtaining the line profiles of FIGS. 4 and 5 is limited by detection accuracy. The line profiles shown in FIGS. 4 and 5 do not suggest that the samples have no intermediate layer.

### (2) Manufacturing Method of Laminated Ceramic Capacitor 1

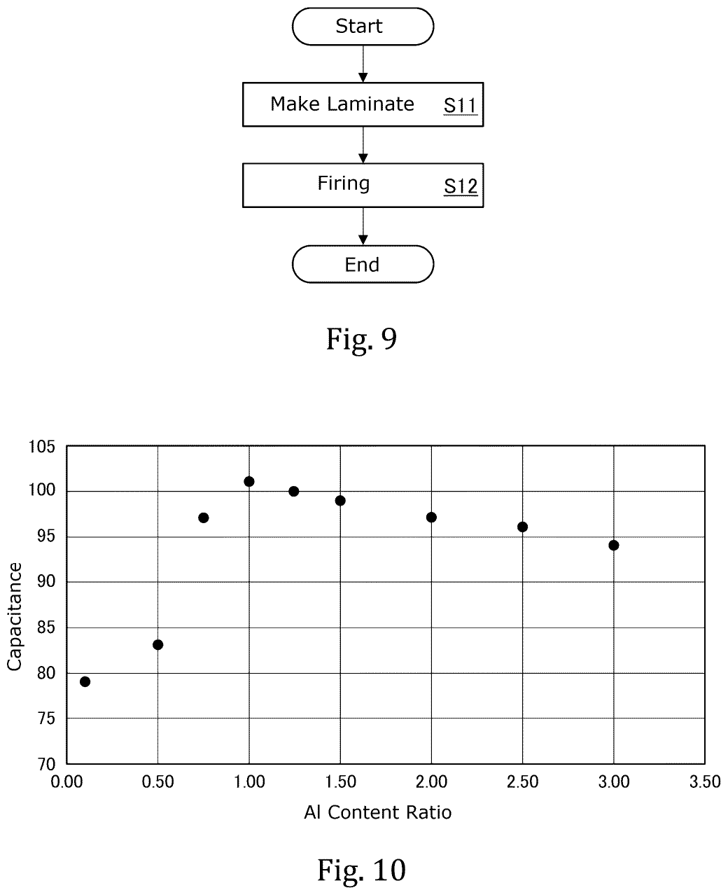

A description will now be given of one example of the manufacturing method of the laminated ceramic capacitor 1 with reference to FIG. 9. FIG. 9 is a flowchart showing a flow of a manufacturing method of a laminated ceramic capacitor according to one embodiment of the disclosure.

A brief description is given of the manufacturing method shown in FIG. 9. To begin with, in the step S11, a laminate is formed as the precursor of the body 10. The laminate includes dielectric green sheets, which are the precursor of the dielectric layers 11, and internal electrode patterns, which are the precursor of the first and second internal electrode layers 21 and 22. The laminate may be formed by alternately stacking dielectric green sheets each having an internal electrode pattern on the surface thereof which is the precursor of the first internal electrode layer 21, and dielectric green sheets each having an internal electrode pattern on the surface thereof which is the precursor of the second internal electrode layer 22. In the next step S12, the laminate formed in the step S11 is heated in a firing furnace to fire the dielectric green sheets and internal electrode patterns. In this manner, the laminated ceramic capacitor 1 is manufactured.

The following describes each of the steps shown in FIG. 9 in more detail. First, in the step S11, dielectric powder is wet-mixed with a binder such as polyvinyl butyral (PVB) resin, an organic solvent such as ethanol or toluene, and a plasticizer to obtain a slurry. This slurry is coated on a substrate film using, for example, the die coater or doctor blade method, and then the slurry coated on the substrate film is dried, to obtain a dielectric green sheet. The dielectric green sheets are the precursor of the dielectric layers 11.

The dielectric powder used as the raw powder of the dielectric green sheets is, for example, barium titanate powder. Barium titanate powder is synthesized by reacting titanium raw material such as titanium dioxide with barium raw material such as barium carbonate by a known method such as the solid phase method, the sol-gel method, or the hydrothermal method.

Next, an internal electrode pattern is formed on each of the dielectric green sheets formed as described above. The internal electrode pattern is formed, for example, by printing a paste for the internal electrodes on the dielectric green sheet using screen printing or other known printing methods. When the internal electrode patterns are formed by screen printing, the paste for the internal electrodes is produced by kneading and mixing a metal powder, a binder resin, and a solvent by a three-roll mill. In other words, the paste for the internal electrodes is a solvent containing a metal powder dispersed therein. The metal powder contained in the paste for the internal electrodes may be a powder mixture produced by mixing Ni powder with an Fe-containing powder containing Fe and an Al-containing powder containing Al. The Fe-containing powder is, for example, Fe₂O₃ powder. The metal powder contained in the paste for the internal electrodes may be composite particles produced by feeding Ni powder into an organic solvent in which aluminum resinate is dissolved, dispersing the Ni powder in the solution, and then evaporating the solvent. The composite particles formed in this manner are composed of Ni particles with Al dispersed and adhered to their surfaces. The metal powder contained in the paste for the internal electrodes may be a powder of an alloy of Ni and Al. The metal powder contained in the paste for the internal electrodes may be a coated powder with an Al-containing coating layer on the surface of Ni. The Al-containing powder is, for example, Al₂O₃ powder. The powder mixture is prepared by weighing the Fe-containing powder so that the Fe content ratio to 100 at % Ni is in the range of 0.01 to 10 at %, and weighing the Al-containing powder so that the Al content ratio to 100 at % Ni is in the range of 0.01 to 10 at %, and mixing these weighed Fe-containing and Al-containing powders with Ni powder. The organic binder used in the paste for the internal electrodes may be a cellulose-based resin such as ethyl cellulose or an acrylic resin such as butyl methacrylate. The internal electrode patterns formed on some of the dielectric green sheets are the precursor of the first internal electrode layers 21, and the internal electrode patterns formed on the others of the dielectric green sheets are the precursor of the second internal electrode layers 22.

The internal electrode patterns may be formed on the dielectric green sheets by the sputtering method. The method of forming the internal electrode patterns is not limited to that specified herein. The internal electrode patterns may be formed by various known methods, e.g., vacuum deposition, pulsed laser deposition (PLD), metal organic chemical vapor deposition (MO-CVD), metal organic decomposition (MOD), or chemical solution deposition (CSD).

As described above, a lamination unit having a dielectric green sheet and an internal electrode pattern formed on the surface of the dielectric green sheet is obtained. A predetermined number of lamination units are stacked together and thermo-compressed to form a laminate. The top layer and the bottom layer of the laminate may be formed of green sheets that do not have internal electrode patterns formed thereon.

Next, the laminate is diced into pieces to obtain chip-like laminates each being the precursor of the body 10. The chip-like laminates may be subjected to a degreasing process. The degreasing process may be performed in an N₂ atmosphere. The laminates having undergone the degreasing process may be coated with a metal paste by the dip method to form base electrode layers for the first and second external electrodes 31 and 32.

Next, in the step S12, each of the chip laminates produced in the step S11 is placed in a firing furnace, and fired in the firing furnace in accordance with a predetermined temperature profile, thereby producing the laminated ceramic capacitor 1. In the firing furnace, a low oxygen atmosphere with an oxygen partial pressure of 10-12 to 10-10 atm is maintained, for example. The temperature in the firing furnace is first raised from the room temperature to a firing start temperature at the rate of 200 to 1000° C./h and kept at the firing start temperature for 10 minutes to one hour. In other words, in the firing step, the chip laminate is heated at the firing start temperature for 10 minutes to one hour. The firing start temperature is set at 850 to 1100° C. where Ni can be sintered. The temperature in the firing furnace is then increased at a fast rate from the firing start temperature to a firing top temperature. The firing top temperature is, for example, 1150 to 1300° C. The temperature increase rate is, for example, 3000 to 10000° C./h. The temperature in the firing furnace is then kept at the firing top temperature for 10 to 30 minutes, and subsequently lowered. In the above-described manner, the chip laminate is fired into a fired body.

In this firing process, the dielectric green sheets in the chip laminate are fired into the dielectric layers 11, and the internal electrode patterns are fired into the internal electrode layers (the first internal electrode layers 21 and the second internal electrode layers 22). During the firing process, the Fe contained in the internal electrode patterns thermally diffuses toward the interface between the internal electrode patterns and the dielectric green sheets. In this way, the first and second intermediate layers 41 and 42, which contain Fe in a higher concentration than the internal electrode layers, are respectively formed between the dielectric layers 11 and the first internal electrode layers 21 and between the dielectric layers 11 and the second internal electrode layers 22, in the laminated ceramic capacitor 1. During the firing process, not only Fe but also Al diffuses thermally, so the first and second intermediate layers 41 and 42 contain Al as well.

Processes not shown in the flowchart of FIG. 9 may be performed to produce the laminated ceramic capacitor 1. For example, the laminated ceramic capacitor 1 obtained through the firing in the step S12 may be subjected to re-oxidation treatment at 600° C. to 1000° C. in an N₂ gas atmosphere. A plating layer of Cu, Ni, Sn or the like may be provided on the surfaces of the first and second external electrodes 31 and 32. This plating layer can be formed by the electrolytic or electroless plating method.

### (3) First Implementation Example

The invention will now be further described in detail based on examples. The invention is not limited to the following examples.

### (3-1) Preparation of Samples

First, 16 different samples were prepared according to the manufacturing method shown in FIG. 9. Specifically, a slurry was first obtained by wet-mixing barium titanate powder with polyvinyl butyral (PVB) resin, a solvent, and a plasticizer. The slurry was coated on a substrate film, and then the slurry coated on the substrate film was dried to obtain a dielectric green sheet.

Subsequently, predetermined amounts of Fe₂O₃ and Al₂O₃ powders were weighed and mixed with Ni powder to prepare a powder mixture. The amounts of Fe₂O₃ and Al₂O₃ powders added were adjusted so that the resulting Fe and Al concentrations in the internal electrode layers after firing were those listed in Table 1. Neither Fe₂O₃ nor Al₂O₃ powder was added to the internal electrode slurry for sample 14. Only Fe₂O₃ powder was added to the internal electrode slurry for sample 15, and only Al₂O₃ powder was added to the internal electrode slurry for sample 16.

Next, the powder mixture was wet-mixed with polyvinyl butyral (PVB) resin, a solvent, and a plasticizer to obtain a slurry for the internal electrodes.

Then, the slurry for the internal electrodes was printed on a part of the surface of each dielectric green sheet, to form an internal electrode pattern on the dielectric green sheet. In this way, a lamination unit was made. The lamination unit had the dielectric green sheet and the internal electrode pattern formed on the surface of the dielectric green sheet.

Next, 500 lamination units were stacked together to form a laminate, which was then diced into chip laminates. The chip laminates had the 1005 shape (length: 1.0 mm, width: 0.5 mm, height: 0.5 mm). Next, the chip laminates were degreased in an N₂ atmosphere. Next, the base layers of the external electrodes were formed on each of the chip laminates by applying metal paste to the degreased chip laminate by the dip method.

Next, the chip laminate obtained as described above was put into the firing furnace and fired in the firing furnace. In this manner, samples 1 to 16 were made. In samples 1 to 16, the dielectric green sheets were fired into the dielectric layers, and the internal electrode patterns were fired into the internal electrode layers. The base layers formed on the chip laminates were fired into the external electrodes. Therefore, samples 1 to 16 are all laminated ceramic capacitors.

### (3-2) Concentrations of Fe and Al

Next, samples 1 to 16 were sliced using a focused ion beam (FIB) system so that the LT plane (FIG. 2) can be exposed as an observation surface. A sliced analysis specimen with a thickness of 60 nm was taken from each of samples 1 to 16. Damage that appeared on the observation surface of the sliced specimen was removed as appropriate by Ar ion milling. Next, the sliced specimen was placed in a STEM equipped with an EDS detector, and a STEM image was captured for the observation surface of the sliced specimen. The contrast difference in the STEM image was used to identify the internal electrode layers. The TEM used to capture the STEM image was the JEM-210OF available from JEOL Ltd. The EDS detector used was the Dry SD 100 GV detector available from JEOL Ltd.

Following this, 10 sites within the internal electrode layers on the observation surface of the analysis specimen were studied at 100,000× magnification. The concentrations of Ni, Fe, and Al were measured by the EDS for these 10 observation sites. The measurement was performed with the acceleration voltage being set at 200 kV and the electron beam diameter 1.0 nm for a duration of 3 hours. For quantitative evaluation, the spectra of Ni Kα line, Fe Kα line, and Al K line underwent Zaf correction, so that the concentrations of the respective elements were calculated. Based on the concentrations of the respective elements obtained by the EDS measurement, the concentrations of Fe and Al (at %) to 100 at % Ni were calculated. The calculated Fe and Al concentrations are listed in the “Fe Concentration” and “Al Concentration” columns in Table 1 below. The Al content ratio (Al concentration/Fe concentration), which represents the ratio of Al concentration to Fe concentration, was calculated for each sample, and the calculated Al content ratio is listed in the “Al content ratio” column of Table 1.

### (3-3) Verification of Intermediate Layer

Next, in the above analysis specimen, ten observation regions (each corresponding to the observation region B1 in FIG. 6) of 15 nm square extending from an internal electrode layer to a dielectric layer were set and subjected to TEM-EDS analysis under the following conditions: the acceleration voltage of 200 kV, the electron beam diameter of 1.5 nm, and the measurement time of two hours. Specifically, concentration maps representing the concentrations of the quantitative elements (Ba, Ti, O, Ni, Fe and Al) in atomic ratio (at %) were obtained for each observation region and reconstructed along a scanning line SL extending along the T-axis from the internal electrode layer to the dielectric layer within each observation region B1. In this way, the line profiles of the quantitative elements were obtained for each observation region. In the line profiles of samples 1 to 13 and sample 15, the peak of Fe appeared near the intersection of the Ba and Ni profiles similarly to what is shown in FIG. 8. In the line profiles of sample 16, the peak of Al appeared near the intersection of the Ba and Ni profiles. For sample 14, neither the Fe peak nor the Al peak was detected. The results of the line analysis confirmed that an intermediate layer containing Fe was formed between a dielectric layer and an internal electrode layer in samples 1 to 13 and sample 15. The results of the line analysis also confirmed that an intermediate layer containing Al was formed between a dielectric layer and an internal electrode layer.

### (3-4) Capacitance

The capacitance was measured for each of samples 1 to 16. The capacitance was measured using an LCR meter at room temperature, with a measurement voltage of 0.5 V and a frequency of 1 kHz. One hundred pieces were selected for each of samples 1 to 16, and the capacitance was determined for each of these 100 pieces. The average of the capacitances measured for the 100 pieces was calculated for each of samples 1 to 16, and this calculated average was used as the capacitance of the sample. The capacitance calculated in this way is listed in the column of “Capacitance” in Table 1. The column of “Capacitance” in Table 1 shows the relative capacitance of each sample relative to the capacitance of sample 14 (100), which has neither Fe nor Al added. For example, Sample 1 has a capacitance of “79.” This indicates that the capacitance calculated for sample 1 is 79% of that of sample 14.

### (3-5) Insulation Reliability

One hundred pieces were selected for each of samples 1 to 16, and an accelerated life test (HALT) was performed on each of these selected pieces. In the accelerated life test, a voltage of 6 V/μm was applied at 125° C. to the 100 pieces selected for each of samples 1 to 16, and the failure time was measured. The median of the failure time values measured for these 100 pieces was used as the HALT 50% value of each sample. The relative HALT 50% value of each sample was then calculated when the HALT 50% value of sample 14, which has neither Fe nor Al added, was used as the reference (100). The relative HALT 50% values thus calculated are listed in the “Reliability” column of Table 1. For example, Sample 1 has reliability of “158.” This indicates that the HALT 50% value calculated for sample 1 is 158% of that of sample 14.

TABLE 1

| | Fe | Al | Al | | |
|---|---|---|---|---|---|
| Sample | Concentration | Concentration | Content | Capac- | Reli- |
| Number | [at %] | [at %] | Ratio | itance | ability |
| 1* | 1.0 | 0.1 | 0.10 | 79 | 158 |
| 2* | 1.0 | 0.5 | 0.50 | 83 | 170 |
| 3 | 1.0 | 0.75 | 0.75 | 97 | 187 |
| 4 | 1.0 | 1.0 | 1.00 | 101 | 204 |
| 5 | 1.0 | 1.25 | 1.25 | 100 | 198 |
| 6 | 1.0 | 1.5 | 1.50 | 99 | 201 |
| 7 | 1.0 | 2.0 | 2.00 | 97 | 199 |
| 8 | 1.0 | 2.5 | 2.50 | 96 | 174 |
| 9 | 1.0 | 3.0 | 3.00 | 94 | 130 |
| 10 | 0.01 | 0.01 | 1.00 | 103 | 105 |
| 11 | 0.1 | 0.1 | 1.00 | 102 | 120 |
| 12 | 0.5 | 0.5 | 1.00 | 102 | 172 |
| 13 | 5.0 | 5.0 | 1.00 | 98 | 270 |
| 14* | n/a | n/a | n/a | 100 | 100 |
| 15* | 1.0 | n/a | n/a | 75 | 155 |
| 16* | n/a | 1.0 | n/a | 95 | 105 |

In Table 1, the samples not encompassed by the present invention (i.e., comparative examples) have an asterisk (*) added to the sample number. Specifically, samples 1, 2, and 14 to 16 are comparative examples not encompassed by the present invention.

### (3-6) Analysis

The experimental results for samples 14 to 16 are compared. When sample 15 is compared against sample 14, the insulation reliability is improved by 55% while the capacitance is reduced by 25%. The reason why sample 15 has much better insulation reliability than sample 14 can be explained as follows. During the firing process, Fe diffused toward the interfaces between the dielectric layers and the internal electrode layers, thereby forming intermediate layers containing a high concentration of Fe between the dielectric layers and the internal electrode layers. These intermediate layers are thought to have increased the height of the Schottky barrier between the dielectric layers and the internal electrode layers. The significantly lower capacitance of Sample 15 is likely to be attributable to the diffusion of Fe into the dielectric layers during the firing process. The Fe in the dielectric layers is thought to inhibit the polarization reversal of the barium titanate.

When sample 16 is compared against sample 14, the insulation reliability is improved by 5% while the capacitance is reduced by 5%. The reason for the improvement in insulation reliability in sample 16 compared to sample 14 can be explained as follows. During the firing process, Al diffused slightly into the interfaces between the dielectric layers and the internal electrode layers, and the Al present in these interfaces increases the height of the Schottky barrier between the dielectric layers and the internal electrode layers. The lower capacitance of sample 16 may be due to the oxidation of Al in the internal electrode layers and resulting formation of aluminum oxide, which is electrically insulating. The decrease in capacitance and the improvement in insulation reliability observed in sample 16 is less significant than those in sample 15. This is considered to be due to the fact that Al is less thermally diffusible than Fe in the environment where the laminated ceramic capacitors are manufactured.

Comparing the experimental results of samples 14 to 16 can reveal that the samples with only one element selected from Fe and Al added have improved insulation reliability but decreased capacitance.

In contrast, sample 4, in which the internal electrode layers contain the same amount of Fe as sample 15 and the same amount of Al as sample 16, shows a 104% improvement in insulation reliability and a 1% improvement in capacitance compared to sample 14. Specifically, when sample 4 is compared against sample 14, both the capacitance and the insulation reliability are improved. One of the reasons for the improved capacitance in sample 4 can be attributed to the fact that the diffusion of Fe into the dielectric layers was prevented by the bonding of Fe with Al in the internal electrode layers, and the decrease in capacitance due to the increase in the concentration of Fe in the dielectric layers was reduced. Another possible reason for the improved capacitance in sample 4 is that the combination of Fe and Al leads to the formation of the segregated part 25, which is electrically conductive, in the internal electrode layers, and further to an increase in the continuity of the internal electrode layers because of the presence of the segregated part 25. The reason for the improvement in insulation reliability in sample 4 can be explained as follows. During the firing process, the Fe that did not combine with the Al diffused into the interfaces between the dielectric layers and the internal electrode layers, and this increased the height of the Schottky barrier between the dielectric layers and the internal electrode layers.

The following compares the experimental results for samples 10 to 13.

Samples 10 to 13 all contain Fe and Al at the same concentration in the internal electrode layers. Stated differently, the Al content ratio is 1.0 in all of samples 10 to 13. Like sample 4, samples 10 to 12 have better capacitance and higher insulation reliability than sample 14. Sample 13 has a capacitance of 98, which is slightly lower than that of sample 14. However, the reduction is considered to be minor when compared with the drop in capacitance experienced by sample 15 containing no Al, which has a capacitance of 75. The above evaluation indicates that samples 10 to 13, which contain Fe and Al at the same concentration in the internal electrode layers, exhibit both excellent capacitance and high insulation reliability. Samples 10 to 13 exhibit both excellent capacitance and high insulation reliability for the same reasons as sample 4.

The following compares the experimental results for samples 1 to 9. In samples 1 to 9, the Fe concentration in the internal electrode layers is constant at 1.0 at %, and the Al concentration ranges from 0.1 to 3.0. Samples 1 to 9 all exhibited insulation reliability of 130 or higher and were verified to be capable of achieving high insulation reliability. In terms of capacitance, some of the samples outperformed the others depending on their Al content ratio. The relationship between the Al content ratio and the capacitance was examined by preparing the graph shown in FIG. 10. In FIG. 10, the horizontal axis indicates the Al content ratio, and the vertical axis indicates the capacitance. The experimental results for samples 1 to 9 are plotted in the coordinate space of FIG. 10.

The graph in FIG. 10 first shows that high capacitance is realized when the Al content ratio is around 1.0. The graph in FIG. 10 also indicates that the capacitance tends to decrease as the Al content ratio decreases from one. The reason why the capacitance decreases as the Al content ratio decreases from one can be explained as follows. Because of the high Fe content ratio in the internal electrode layers, a significant amount of Fe remains unbonded with Al during the manufacturing process and diffuses into the dielectric layers through thermal diffusion. The graph in FIG. 10 shows that the capacitance is significantly lower in the domain where the Al content ratio is less than 0.75. The reason why the capacitance is significantly lower in the domain where the Al content ratio is less than 0.75 can be explained as follows. When the Fe content is slightly higher than the Al content (when the Al content ratio is no less than 0.75 and less than 1.0), Fe thermally diffuses toward the dielectric layers and stays at the interfaces between the internal electrode layers and the dielectric layers, thereby forming the intermediate layers at the interfaces. On the other hand, if the Fe content is excessively higher than the Al content (when the Al content ratio is less than 0.75), Fe saturates at the interfaces between the internal electrode layers and the dielectric layers, thereby increasing the amount of Fe that thermally diffuses into the dielectric layers.

The graph in FIG. 10 also indicates that the capacitance tends to decrease as the Al content ratio increases from one. The decrease in capacitance in the domain where the Al content ratio is greater than 1 is less significant than that in the domain where the Al content ratio is less than 1. In other words, the capacitance decreases less dramatically in the domain where the Al content ratio is greater than 1 than in the domain where the Al content ratio is less than 1.

The above confirms that both excellent capacitance and high insulation reliability can be achieved when the Al content ratio is from 0.75 to 3.0. According to the above implementation example, the relationship between the Al content ratio, the capacitance and the insulation reliability was evaluated for samples 1 to 9, which contain Fe at a concentration of 1.0 at %. The same relationship between the Al content ratio, the capacitance and the insulation reliability as that shown in FIG. 10 has been verified for samples that have a Fe concentration of 0.01 at % to 5 at %.

The above experiments have also confirmed that more excellent capacitance (97) can be achieved when the Al content ratio is from 0.75 to 2.0 and from 0.75 to 1.5.

The above experiments have also confirmed that even more excellent capacitance (99 or higher) can be exhibited when the Al content ratio is from 1.0 to 1.5.

### (4) Second Implementation Example

The powder mixture used to make sample 4 described above was further mixed with noble metal powder. The resulting powder mixture containing the noble metal powder was used to prepare the slurry for the internal electrodes in the same manner as for sample 4. This alternative internal electrode slurry was used to fabricate a laminated ceramic capacitor using the same method as that for sample 4. The noble metal powder was selected from Au, Ag, and Pt powders. The amount of noble metal powder added was adjusted so that the concentration of the noble metal in the internal electrode layers after firing was 1.0 at %, the same as those of Fe and Al. Three different types of laminated ceramic capacitors were fabricated in the above-described manner and their capacitance and HALT 50% values were measured under the same conditions as in the first implementation example. The laminated ceramic capacitor with the Au powder added had a capacitance of 120 and a HALT 50% value of 350. The laminated ceramic capacitor with the Ag powder added had a capacitance of 110 and a HALT 50% value of 275. The laminated ceramic capacitor with the Pt powder added had a capacitance of 115 and a HALT 50% value of 310. The above results indicate that the capacitance and insulation reliability can be both improved by adding Au, Ag or Pt to the internal electrode layers at the same concentration as Fe and Al.

### (4) Notes

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### (5) Additional Embodiments

Embodiments disclosed herein also include the following.

### Additional Embodiment 1

A laminated ceramic capacitor including:
a body having:
   a first internal electrode layer containing Ni, Fe and Al;
   a second internal electrode layer;
   a dielectric layer disposed between the first and second internal electrode layers; and
   a first intermediate layer disposed between the first internal electrode layer and the dielectric layer, the first intermediate layer containing Fe and Al,
a first external electrode provided on the body so as to be electrically connected to the first internal electrode layer; and
a second external electrode provided on the body so as to be electrically connected to the second internal electrode layer,
wherein an Al content ratio representing a ratio of a concentration of Al to a concentration of Fe in the first internal electrode layer is from 0.75 to 3.0.

### Additional Embodiment 2

The laminated ceramic capacitor of [Additional Embodiment 1], wherein the Al content ratio is 0.75 to 2.5.

### Additional Embodiment 3

The laminated ceramic capacitor of [Additional Embodiment 2], wherein the Al content ratio is 0.75 to 1.5.

### Additional Embodiment 4

The laminated ceramic capacitor of [Additional Embodiment 3], wherein the Al content ratio is 1.0 to 1.5.

### Additional Embodiment 5

The laminated ceramic capacitor of any one of [Additional Embodiment 1] to [Additional Embodiment 4], wherein the concentration of Fe in the first internal electrode layer is from 0.01 at % to 5 at %.

### Additional Embodiment 6

The laminated ceramic capacitor of [Additional Embodiment 5], wherein the concentration of Fe in the first internal electrode layer is from 0.1 at % to 5 at %.

### Additional Embodiment 7

The laminated ceramic capacitor of any one of [Additional Embodiment 1] to [Additional Embodiment 6], wherein the first internal electrode layer includes a segregated part where Fe and Al are segregated.

### Additional Embodiment 8

The laminated ceramic capacitor of any one of [Additional Embodiment 1] to [Additional Embodiment 7], wherein the first internal electrode layer contains at least one noble metal element selected from the group consisting of Au, Pt, and Ag.

### Additional Embodiment 9

The laminated ceramic capacitor of any one of [Additional Embodiment 1] to [Additional Embodiment 8], wherein the first internal electrode layer contains the noble metal element at a concentration of 0.01 at % to 5 at %.

### Additional Embodiment 10

The laminated ceramic capacitor of any one of [Additional Embodiment 1] to [Additional Embodiment 9],
wherein the second internal electrode layer contains Ni, Fe and Al.
wherein the body further has a second intermediate layer containing Fe and Al between the second internal electrode layer and the dielectric layer, and
wherein an Al content ratio representing a ratio of a concentration of Al to a concentration of Fe in the second internal electrode layer is from 0.75 to 3.0.

### Additional Embodiment 11

A circuit module including the laminated ceramic capacitor of any one of [Additional Embodiment 1] to [Additional Embodiment 10].

### Additional Embodiment 12

An electronic device including the circuit module of [Additional Embodiment 11].

What is claimed is:

1. A laminated ceramic capacitor comprising:
a body having:
a first internal electrode layer containing Ni, Fe and Al;
a second internal electrode layer;
a dielectric layer disposed between the first and second internal electrode layers; and
a first intermediate layer disposed between the first internal electrode layer and the dielectric layer, the first intermediate layer containing Fe and Al,
a first external electrode provided on the body so as to be electrically connected to the first internal electrode layer; and
a second external electrode provided on the body so as to be electrically connected to the second internal electrode layer,
wherein an Al content ratio representing a ratio of a concentration of Al to a concentration of Fe in the first internal electrode layer is from 0.75 to 3.0.

2. The laminated ceramic capacitor of claim 1, wherein the Al content ratio is 0.75 to 2.5.

3. The laminated ceramic capacitor of claim 2, wherein the Al content ratio is 0.75 to 1.5.

4. The laminated ceramic capacitor of claim 3, wherein the Al content ratio is 1.0 to 1.5.

5. The laminated ceramic capacitor of claim 1, wherein the concentration of Fe in the first internal electrode layer is from 0.01 at % to 5 at %.

6. The laminated ceramic capacitor of claim 5, wherein the concentration of Fe in the first internal electrode layer is from 0.1 at % to 5 at %.

7. The laminated ceramic capacitor of claim 1, wherein the first internal electrode layer includes a segregated part where Fe and Al are segregated.

8. The laminated ceramic capacitor of claim 1, wherein the first internal electrode layer contains at least one noble metal element selected from the group consisting of Au, Pt, and Ag.

9. The laminated ceramic capacitor of claim 8, wherein the first internal electrode layer contains the at least one noble metal element at a concentration of 0.01 at % to 5 at %.

10. The laminated ceramic capacitor of claim 1,
wherein the second internal electrode layer contains Ni, Fe and Al,
wherein the body further has a second intermediate layer containing Fe and Al between the second internal electrode layer and the dielectric layer, and
wherein an Al content ratio representing a ratio of a concentration of Al to a concentration of Fe in the second internal electrode layer is from 0.75 to 3.0.

11. A circuit module comprising the laminated ceramic capacitor of claim 1.

12. An electronic device comprising the circuit module of claim 11.
